(19) United States
(12) Patent Application Publication
(10) Pub. No.: US 2008/0028386 A1
(43) Pub. Date: Jan. 31, 2008

(54) Transmission apparatus and method of automatically updating software

(75) Inventors: Kazuaki Nagamine, Kawasaki (JP); Taro Asao, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/878,926

(22) Filed: Jul. 27, 2007

(30) Foreign Application Priority Data
Jul. 31, 2006 (JP) 2006-209178

(51) Int. Cl. G06F 9/44

(52) U.S. Cl. 717/170

(57) ABSTRACT

A first determining unit determines whether a first software installed in a communication control unit is compatible with a second software installed in a transmission apparatus. A second determining unit determines whether a communication control by the communication control unit is interrupted by an update of the first software. An updating unit installs a predetermined software to the communication control unit based on a result of determination by a third determining unit that determines whether to automatically update the first software based on results of determination by the first and the second determining units.

### BACKGROUND OF THE INVENTION

1. Field of the Invention

The present invention relates to a technology for automatically updating software installed in communication control units without interrupting a communication.

2. Description of the Related Art

Recently, there is widespread use of transmission apparatuses that include a plurality of slots, where communication control units are mounted on a given combination. These transmission apparatuses are termed “chassis-type”. They have excellent expandability and can achieve a redundant configuration where necessary.

Generally, in a chassis-type transmission apparatus, a software (firmware) that is installed in each communication control unit monitors the statuses of various functions of a local unit, to increase reliability. Software installed in the transmission apparatus main unit collects the monitoring results, and performs warning processes and the like relating to errors.

Pieces of software installed in the communication control units and the transmission apparatus main unit are upgraded for defect repair and functional improvements, and the pieces of software sometimes become incompatible with old versions. In a chassis-type transmission apparatus, this can lead to a loss of connectivity between the software of the communication control unit and the software of the transmission apparatus main unit, such as when a communication control unit including an old version of the software is newly added, whereby the failure monitoring function ceases to function.

To avoid problems in the failure monitoring function caused by inconsistency between software versions, some chassis-type transmission apparatuses include a function that stores software for various communication control units that is compatible with software of a local apparatus in a flash memory or the like, and, in cases such as when a newly added communication control unit includes incompatible software, automatically installs the software stored by the local apparatus to the communication control unit.

Verification as to whether pieces of software are compatible can be performed by a technique disclosed in, for example, Japanese Patent Application Laid-open No. 2005-25543.

However, since the above technique of automatically installing software to a communication control unit compulsorily executes an automatic update when software incompatibility is detected, it cannot be applied in all chassis-type transmission apparatuses. For example, the technique cannot be applied in a transmission apparatus that mounts a communication control unit whose communication control function temporarily stops when software is installed, due to a possibility that communication will be interrupted during execution.

### SUMMARY OF THE INVENTION

It is an object of the present invention to at least partially solve the problems in the conventional technology.

A transmission apparatus according to one aspect of the present invention, in which a plurality of detachable communication control units can be mounted, includes a first determining unit that compares version information of a first software installed in a communication control unit with version information of a second software installed in the transmission apparatus, and determines whether information can be exchanged normally between the communication control unit and the transmission apparatus; a second determining unit that determines whether a communication control being executed by the communication control unit is interrupted by an update of the first software; a third determining unit that determines whether to execute a process of automatically updating the first software, based on results of determination by the first determining unit and the second determining unit; and an updating unit that installs a software stored in a predetermined storage unit to the communication control unit, when the third determining unit determines that the process of automatically updating the first software is necessary.

A method according to another aspect of the present invention is for automatically updating a software installed in a communication control unit by a transmission apparatus in which a plurality of detachable communication control units can be mounted. The method includes first determining including comparing version information of a first software installed in a communication control unit with version information of a second software installed in the transmission apparatus, and determining whether information can be exchanged normally between the communication control unit and the transmission apparatus; second determining including determining whether a communication control being executed by the communication control unit is interrupted by an update of the first software; third determining including determining whether to execute a process of automatically updating the first software, based on results of determination at the first determining and the second determining; and installing a software stored in a predetermined storage unit to the communication control unit, when it is determined that the process of automatically updating the first software is necessary at the third determining.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is one example of an overall configuration of a transmission apparatus according to an embodiment of the present invention;

FIG. 2 is another example of an overall configuration of the transmission apparatus according to the present embodiment;

FIG. 3 is a functional block diagram of the configuration of relevant parts of the transmission apparatus according to the present embodiment;

FIG. 4 is one example of data configuration of a connectivity management table;

FIG. 5 is one example of data configuration of a software management table;

FIG. 6 is one example of connectivity determination results of a connectivity determining unit;

FIG. 7 is a determination logic of an automatic-update-necessity determining unit; and

FIG. 8 is a flowchart of a process procedure of a transmission apparatus according to the present embodiment.

### DETAILED DESCRIPTION OF THE PREFERRED EMBODIMENTS

Exemplary embodiments of the present invention will be explained below in detail with reference to the accompanying drawings.

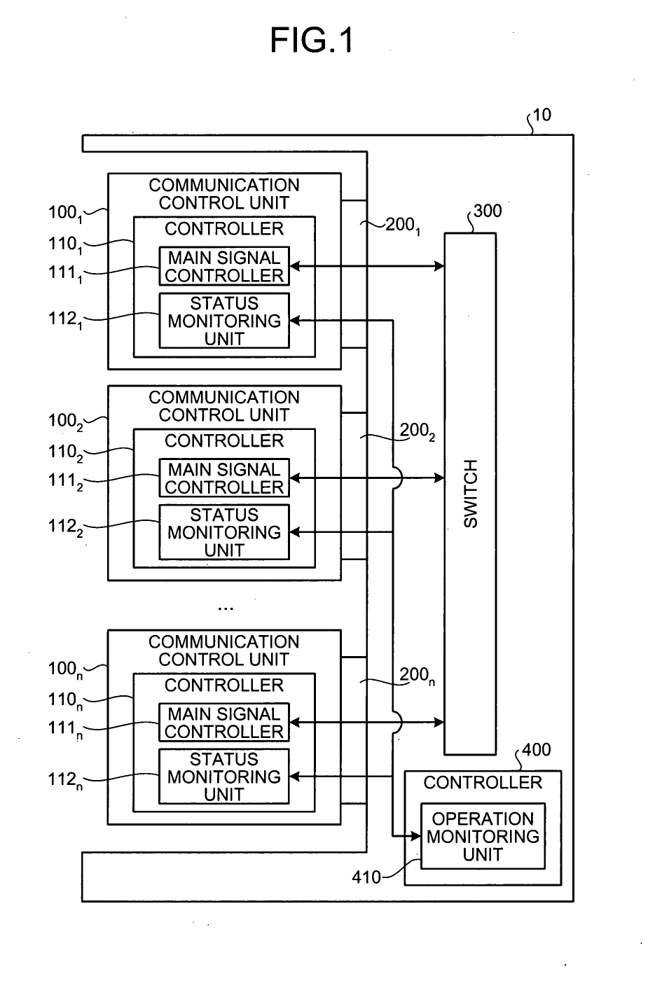

An overall configuration of the transmission apparatus and a summary of the software automatic update method according to an embodiment will be explained first. FIG. 1 is one example of an overall configuration of a transmission apparatus according to the present embodiment. As shown in FIG. 1, a transmission apparatus 10 is a chassis-type transmission apparatus on which communication control units 100₁ to 100ₙ are mounted. The communication control units 100₁ to 100ₙ are connected to the transmission apparatus 10 via respective connectors 200₁ to 200ₙ.

The communication control unit 100₁ performs predetermined communication controls required for achieving a network connection (for example, optical network connection), and includes a controller 110₁. The controller 110₁ includes a main signal controller 111₁ that controls exchange of data packets and packets for control, and a status monitoring unit 112₁ that monitors statuses of various functions of the communication control unit 100₁.

Similarly, the communication control unit 100₂ performs predetermined communication controls required for achieving a network connection, and includes a controller 110₂. The controller 110₂ includes a main signal controller 111₂ that controls exchange of data packets and packets for control, and a status monitoring unit 112₂ that monitors statuses of various functions of the communication control unit 100₂.

Similarly, the communication control unit 100ₙ performs predetermined communication controls required for achieving a network connection, and includes a controller 110ₙ. The controller 110ₙ includes a main signal controller 111ₙ that controls exchange of data packets and packets for control, and a status monitoring unit 112ₙ that monitors statuses of various functions of the communication control unit 100ₙ.

In addition to the connectors 200₁ to 200ₙ, the transmission apparatus 10 also includes a switch 300 and a controller 400. The switch 300 is a transmission path via which main signal controllers 111₁ to 111ₙ exchange data packets and packets for control within the transmission apparatus 10. The controller 400 controls the transmission apparatus 10, and includes an operation monitoring unit 410. The operation monitoring unit 410 is a processor that collects monitoring results of the status monitoring units 112₁ to 112ₙ, and, if there is an irregularity, executes a warning process such as displaying a warning on a management terminal.

The functions of the operation monitoring unit 410, the main signal controllers 111₁ to 111ₙ, and the status monitoring units 112₁ to 112ₙ shown in FIG. 1 are achieved by software (firmware).

Software for achieving the function of the operation monitoring unit 410 is stored in a storage device of the transmission apparatus 10. When power is turned on, the software is read by a central processing unit (CPU), a digital signal processor (DSP), or a field programmable gate array (FPGA) of the controller 400, and the function of the operation monitoring unit 410 is achieved.

Similarly, pieces of software for achieving functions of the main signal controllers 111₁ to 111ₙ and the status monitoring units 112₁ to 112ₙ are stored in storage devices of their respective communication control units. When power is turned on, the software is read by a CPU, a DSP, or an FPGA of the controller of the respective communication control unit, and predetermined functions are achieved.

Each piece of software is upgraded for defect repair and functional improvements, and sometimes becomes incompatible with software of the earlier version. Therefore, to enable the operation monitoring unit 410 to execute its function of monitoring operations in cooperation with the status monitoring units 112₁ to 112ₙ, the version of the software for achieving the function of the operation monitoring unit 410 must be compatible with the version of the software for achieving the functions of the status monitoring units 112₁ to 112ₙ.

However, during an actual operation, the operation monitoring function can cease to function due to inconsistency between software versions, such as when a communication control unit breaks down and is replaced with a spare replacement unit. To prevent such situations, the transmission apparatus 10 stores software for various communication control units that are compatible with its own software in the local apparatus.

When a communication control unit having software that is incompatible with the software of the transmission apparatus 10 is mounted, the transmission apparatus 10 automatically installs the software that it stores to the communication control unit, thereby ensuring compatibility. Automatic updates of the software are not always executed compulsorily. Instead, the software is automatically updated only when this does not adversely affect communication control, which is the main purpose of the transmission apparatus 10.

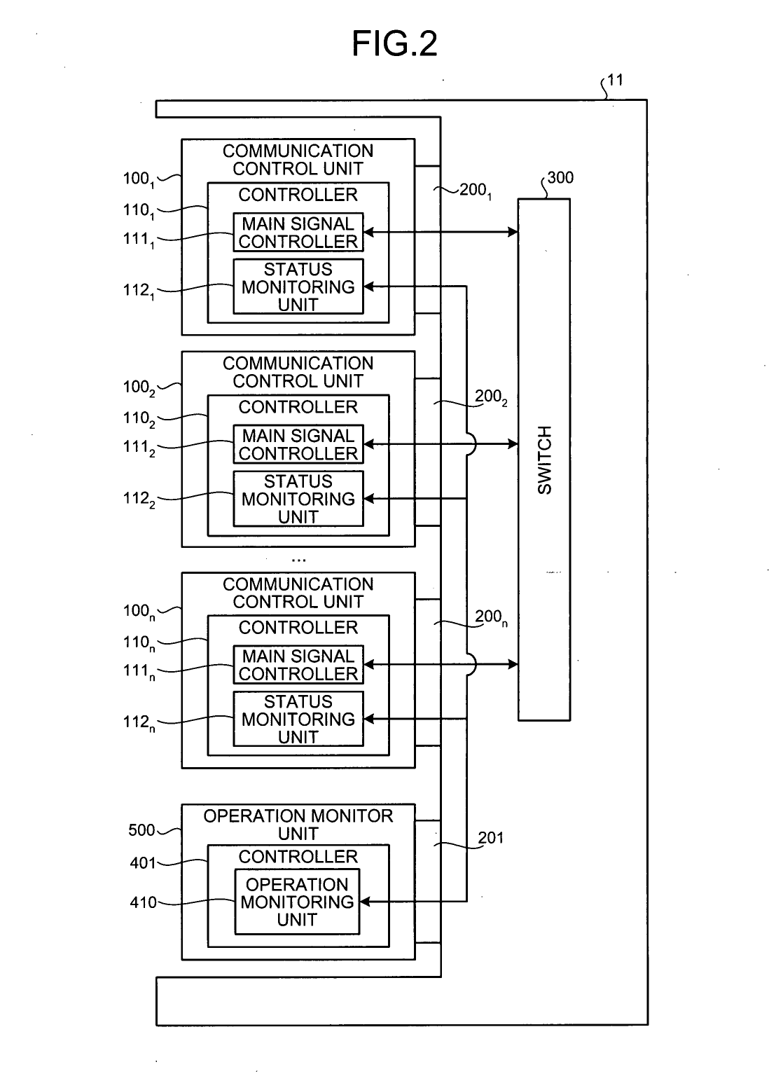

While the transmission apparatus 10 shown in FIG. 1 is configured with the operation monitoring unit 410 inside the main unit of the transmission apparatus 10, it can be provided outside the main unit, as is the case with a transmission apparatus 11 shown in FIG. 2.

An operation monitor unit 500 connects to the transmission apparatus 11 via a connector 201. The operation monitoring unit 410 is incorporated in a controller included in the operation monitor unit 500. With this configuration, software that achieves the function of the operation monitoring unit 410 is stored in a storage device of the operation monitor unit 500. A controller 401 of the operation monitor unit 500 also includes various processors for automatically updating software as described below.

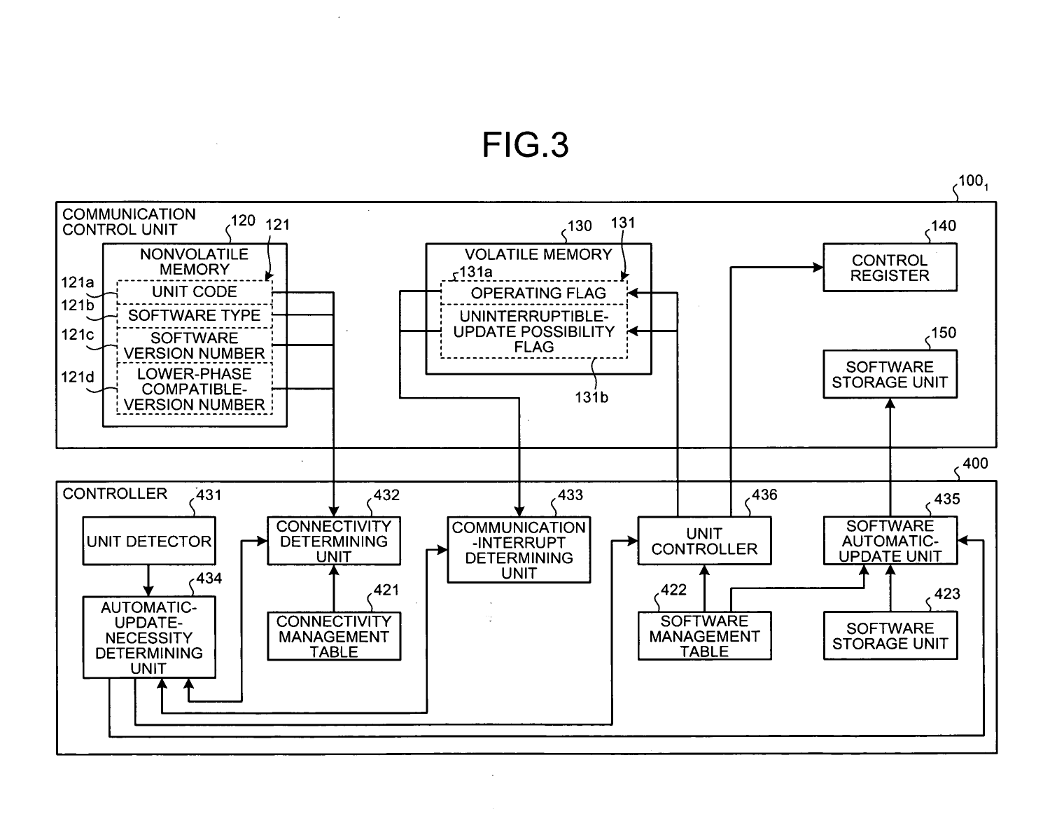

Subsequently, a configuration for achieving a software automatic update method according to the present embodiment will be explained, taking the transmission apparatus 10 shown in FIG. 1 as an example. FIG. 3 is a functional block diagram of the configuration of relevant parts of the transmission apparatus 10 according to the present embodiment. In FIG. 3, parts of the configuration that are unrelated to automatic update of software are not shown. While FIG. 3 depicts a configuration of the communication control unit 100₁ by way of example, the communication control units 100₂ to 100₁ shown in FIG. 1 have configurations similar to that of the communication control unit 100₁.

As shown in FIG. 3, the communication control unit 100₁ has a nonvolatile memory 120, a volatile memory 130, a control register 140, and a software storage unit 150.

The nonvolatile memory 120 can continue storing information even after the power of the transmission apparatus 10 is turned off, and stores information including a unit code 121a, a software type 121b, a software version number 121c, and a lower-phase compatible-version number 121d.

The unit code 121a is an identification code that indicates the category of the communication control unit, and the software type 121b is an identification code for specifying, in combination with the unit code 121a, software that can be installed in the communication control unit. The software version number 121c indicates the version of software currently in the communication control unit, and the lower-phase compatible-version number 121d indicates which earlier version the software currently installed in the communication control unit has lower phase compatibility with.

For example, when the software version number 121c has a value of “05” and the lower-phase compatible-version number 121d has a value of “02”, this indicates that the version of the software currently in the communication control unit is “05” and that this software has similar connectivity when the version number is “02”. In this specification, “having connectivity” signifies that the software can exchange information normally with another software according to a predetermined procedure.

To ensure connectivity between two pieces of software, a minimum requirement is that versions of both are compatible. More preferably, both are the latest versions.

The volatile memory 130 loses information when the power of the transmission apparatus 10 is turned off, and stores operation status flags 131 including an in-operation flag 131a and an uninterruptible-update possibility flag 131b.

The in-operation flag 131a indicates whether the communication control unit is operating, i.e., whether it is in a state of executing communication control. Since the in-operation flag 131a is provided in the volatile memory 130, it is invariably reset after power is turned on to the transmission apparatus 10 and correctly indicates that the communication control unit is not operating. The uninterruptible-update possibility flag 131b indicates whether the communication control unit can update its software while executing communication control, without interrupting the communication for even a moment.

The control register 140 is used in setting various parameters that controls operations of the main signal controller 111₁. The software storage unit 150 stores software for achieving functions of the main signal controller 111₁ and the status monitoring unit 112₁.

The controller 400 includes a connectivity management table 421, a software management table 422, a software storage unit 423, a unit detector 431, a connectivity determining unit 432, a communication-interrupt determining unit 433, an automatic-update-necessity determining unit 434, a software automatic-update unit 435, and a unit controller 436.

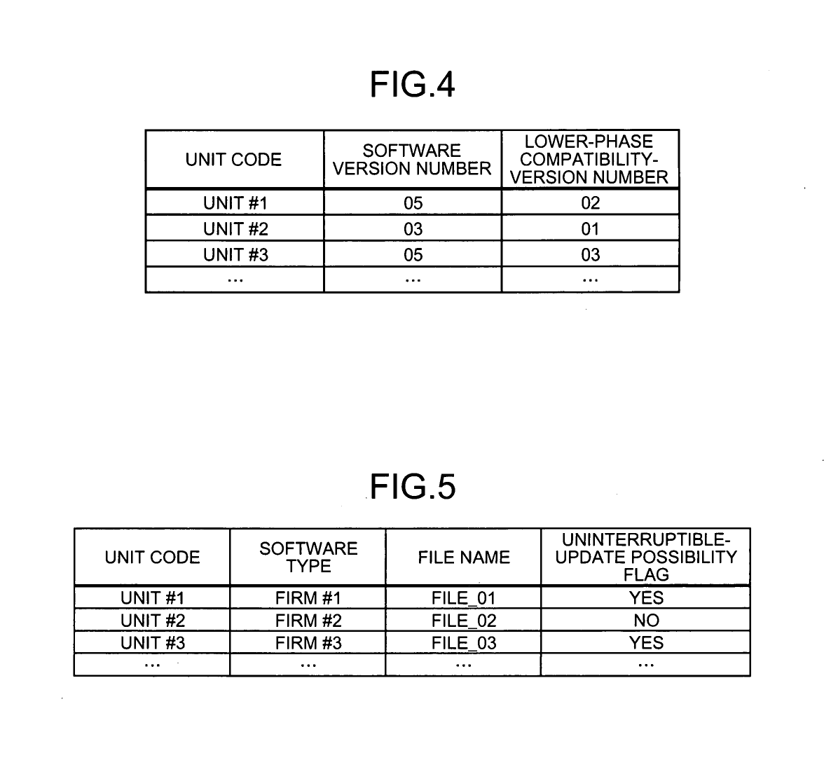

The connectivity management table 421 stores information indicating connectivity between software that achieves functions of the operation monitoring unit 410 and software installed in the various communication control units. FIG. 4 is one example of the connectivity management table 421. As shown in FIG. 4, items in the connectivity management table 421 include unit code, software version number, and lower-phase compatibility-version number, with data being stored for each unit code.

A unit code is an identification code that indicates the category of a communication control unit. A software version number indicates the version of software corresponding to a communication control unit identified by that unit code, among the software for automatic update stored in the software storage unit 423. A lower-phase compatibility-version number indicates the oldest compatible version of software that achieves the function of the operation monitoring unit 410, among the versions of software that can be installed in the communication control unit identified by the unit code.

The software management table 422 stores information relating to software for automatic update stored in the software storage unit 423. FIG. 5 is one example of the software management table 422. As shown in FIG. 5, items in the software management table 422 include unit code, software type, file name, and uninterruptible-update possibility flag, with data being stored for each combination of unit code and software type.

A unit code is an identification code that indicates the category of the communication control unit, and a software type is an identification code for identifying software that can be installed in the communication control unit indicated by that unit code. A file name is a name of software identified by a combination of a unit code and a software type, and an uninterruptible-update possibility flag indicates whether communication control being executed will be interrupted by installing the software to the communication control unit.

The software storage unit 423 stores pieces of software that can be installed in the various communication control units mounted on the transmission apparatus 10. Software having connectivity with software that achieves the function of the operation monitoring unit 410 is stored in the software storage unit 423. Instead of being stored in the transmission apparatus 10, pieces of software that can be installed in the various communication control units mounted on the transmission apparatus 10 can be stored in a server device or the like connected to the transmission apparatus 10 via a network.

The unit detector 431 is a processor that, when a communication control unit is newly implemented in the transmission apparatus 10 while it is running, detects this and notifies the automatic-update-necessity determining unit 434. The connectivity determining unit 432 is a processor that refers to unit information 121 of the communication control unit specified by the automatic-update-necessity determining unit 434 and information stored in the connectivity management table 421, and determines whether software in the communication control unit has connectivity with software that achieves the function of the operation monitoring unit 410.

The connectivity determining unit 432 compares the range of the software version number 121c and the lower-phase compatible-version number 121d in the unit information 121 of the communication control unit specified by the automatic-update-necessity determining unit 434 with the range of the software version number and the lower-phase compatible-version number in the information of the connectivity management table 421 corresponding to that communication control unit, and, if there is an overlap, determines that they are compatible. When the connectivity determining unit 432 determines that the pieces of software are compatible, it compares the software version number 121c of the unit information 121 with the software version number of the connectivity management table 421, and determines whether the software in the communication control unit is the latest version.

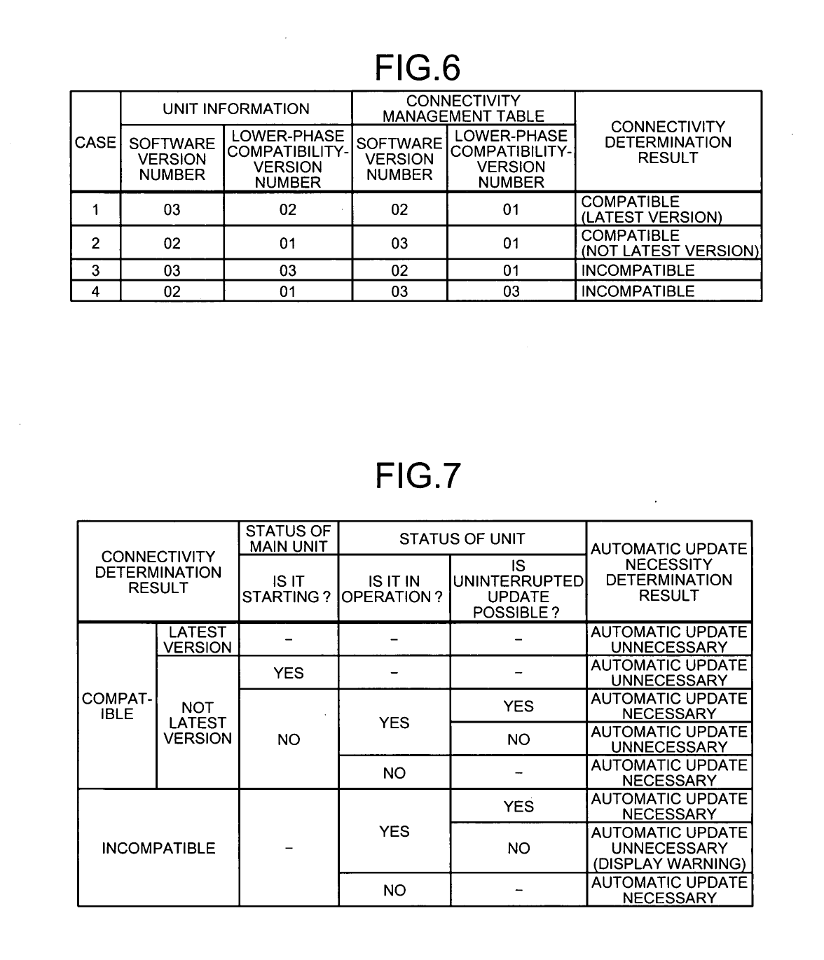

FIG. 6 is one example of connectivity determination results of the connectivity determining unit 432. In case 1, there is an overlap in the range indicated by the version number and the software version number 121c, and the software version number 121c of the unit information 121 is newer than the software version number of the connectivity management table 421. Therefore, the connectivity determining unit 432 determines that these pieces of software are compatible, and that the software in the communication control unit is the latest.

In case 2, while there is an overlap in the range indicated by the version numbers, the software version number 121c of the unit information 121 is older than the software version number of the connectivity management table 421. Therefore, the connectivity determining unit 432 determines that, while the pieces of software are compatible, the software in the communication control unit is not the latest.

In case 3, the software in the communication control unit is new, and there is no overlap in the range indicated by the version numbers. Therefore, the connectivity determining unit 432 determines that these pieces of software are not compatible. In case 4, the software in the communication control unit is old, and there is no overlap in the range indicated by the version number. Therefore, the connectivity determining unit 432 determines that these pieces of software are not compatible.

The communication-interrupt determining unit 433 is a processor that refers to the operation status flags 131 of the communication control unit specified by the automatic-update-necessity determining unit 434, and, when installing software to that communication control unit, determines whether a communication being executed by the communication control unit will be interrupted.

Specifically, when the in-operation flag 131a indicates that the communication control unit is in operation and the uninterruptible-update possibility flag 131b does not indicate that the communication control unit can update its software while executing communication control without interrupting communication for even a moment, the communication-interrupt determining unit 433 determines that the communication being executed when software is installed might be interrupted. In all other cases, the communication-interrupt determining unit 433 determines that there is no such possibility.

As described above, the in-operation flag 131a exists in the volatile memory 130, and is unfailingly correct in indicating that the communication control unit is not executing an operation after turning on the power to the transmission apparatus 10. Therefore, from the start of communication control by the communication control unit until the value of the in-operation flag 131a changes, the communication-interrupt determining unit 433 can determine without error that the communication being executed when software is installed will not be interrupted.

The automatic-update-necessity determining unit 434 is a processor that determines whether the transmission apparatus 10 is starting, and determines, based on determination results of the connectivity determining unit 432 and the communication-interrupt determining unit 433, whether software should be automatically updated to the communication control unit.

There are three timings when the automatic-update-necessity determining unit 434 determines whether software should be automatically updated to the communication control unit. The first timing is when power is turned on to the transmission apparatus 10. The second timing is when software that achieves the function of the operation monitoring unit 410 is updated by a manager or the like while the transmission apparatus 10 is operating. The third timing is when the unit detector 431 detects that a new communication control unit is mounted while the transmission apparatus 10 is operating.

At the first and second timings, the automatic-update-necessity determining unit 434 executes a determination process with the respective communication control units mounted on the transmission apparatus 10 as its targets, and at the third timing, the automatic-update-necessity determining unit 434 executes a determination process with the newly mounted communication control unit as its target.

When the automatic-update-necessity determining unit 434 determines the software should be automatically updated to a particular communication control unit, it specifies the unit code 121a and the software type 121b included in the unit information 121 of that communication control unit, and commands the software automatic-update unit 435 to execute a software automatic update process. On the other hand, when the automatic-update-necessity determining unit 434 determines the software need not be automatically updated to a particular communication control unit it commands the unit controller 436 to start an operation of that communication control unit, if the operation has not already started.

FIG. 7 is a determination logic of the automatic-update-necessity determining unit 434. As shown in FIG. 7, when the connectivity determining unit 432 determines that the software in the communication control unit that is the target of the determination is compatible, and that it is the latest version, the automatic-update-necessity determining unit 434 determines that an automatic update of the software is unnecessary, regardless of other conditions.

When the connectivity determining unit 432 determines that the software in the target communication control unit, although compatible, is not the latest version, if the transmission apparatus 10 is starting, the automatic-update-necessity determining unit 434 determines that an automatic update of the software is unnecessary, regardless of the determination result of the communication-interrupt determining unit 433. This is to prevent a long communication recovery time caused by automatically updating software when recovering from system breakdowns and when reactivating to repair damage.

Furthermore, when the connectivity determining unit 432 determines that the software in the target communication control unit, although compatible, is not the latest version, unless the transmission apparatus 10 is starting, the automatic-update-necessity determining unit 434 determines that the necessity of automatically updating the software based on the determination result of the communication-interrupt determining unit 433.

Specifically, when the communication-interrupt determining unit 433 determines that there is a possibility of a communication being interrupted by automatically updating the software (when the in-operation flag 131a of the target communication control unit does not indicate that the communication control unit is executing an operation, and the uninterruptible-update possibility flag 131b indicates that the communication control unit can update its software while executing communication control without interrupting communication for even a moment), the automatic-update-necessity determining unit 434 determines that an automatic update of the software is unnecessary.

On the other hand, when the communication-interrupt determining unit 433 determines that there is a possibility of a communication being interrupted by automatically updating the software (when the in-operation flag 131a and the uninterruptible-update possibility flag 131b of the target communication control unit have a combination of values other than those mentioned above), the automatic-update-necessity determining unit 434 determines that an automatic update of the software is necessary.

When the connectivity determining unit 432 determines that the software of the target communication control unit is not compatible, regardless of whether the transmission apparatus 10 is starting, the automatic-update-necessity determining unit 434 determines, based on the determination result of the communication-interrupt determining unit 433, whether an automatic update of the software is necessary.

Specifically, when the communication-interrupt determining unit 433 determines that there is a possibility of a communication being interrupted by automatically updating the software (when the in-operation flag 131a of the target communication control unit indicates that the communication control unit is executing an operation, and the uninterruptible-update possibility flag 131b does not indicate that the communication control unit can update its software while executing communication control without interrupting communication for even a moment), the automatic-update-necessity determining unit 434 determines that an automatic update of the software is unnecessary.

In this case, while communication control in the target communication control unit continues without interruption, connectivity between the software in that communication control unit and the operation monitoring unit 410 is lost. Consequently, even if some type of failure occurs in the target communication control unit, the operation monitoring unit 410 cannot detect it. Therefore, in this case, the automatic-update-necessity determining unit 434 warns the manager by displaying the loss of connectivity with the target communication control unit on a management terminal or the like.

On the other hand, when the communication-interrupt determining unit 433 determines that there is no possibility of communication being interrupted by automatically updating the software (when the in-operation flag 131a and the uninterruptible-update possibility flag 131b of the target communication control unit have a combination of values other than those mentioned above), the automatic-update-necessity determining unit 434 determines that an automatic update of the software is necessary.

The software automatic-update unit 435 is a processor that executes an automatic update process of software in a communication control unit specified by the automatic-update-necessity determining unit 434. Specifically, the software automatic-update unit 435 searches the software management table 422 using the unit code and the software type specified by the automatic-update-necessity determining unit 434 as keys, extracts the file name of the software to be installed, reads the software with the file name from the software storage unit 423, and writes it to the software storage unit 150 of the communication control unit that is the target of determination.

After the software automatic-update unit 435 writes the software to the software storage unit 150, the software version number 121c and the lower-phase compatible-version number 121d are updated based on information included in the software. This update process can be executed by the software automatic-update unit 435, or by a predetermined processor of the communication control unit.

The unit controller 436 is a processor that controls the communication control unit as necessary by setting predetermined parameters in the control register 140. In switching a communication control unit that is not operating to operating status, the unit controller 436 sets the in-operation flag 131a of the communication control unit such as to indicate that the communication control unit is operating. At this time, the unit controller 436 also extracts the value of an uninterruptible-update possibility flag corresponding to the values of the unit code 121a and the software type 121b of the communication control unit from the software management table 422, and sets the uninterruptible-update possibility flag 131b.

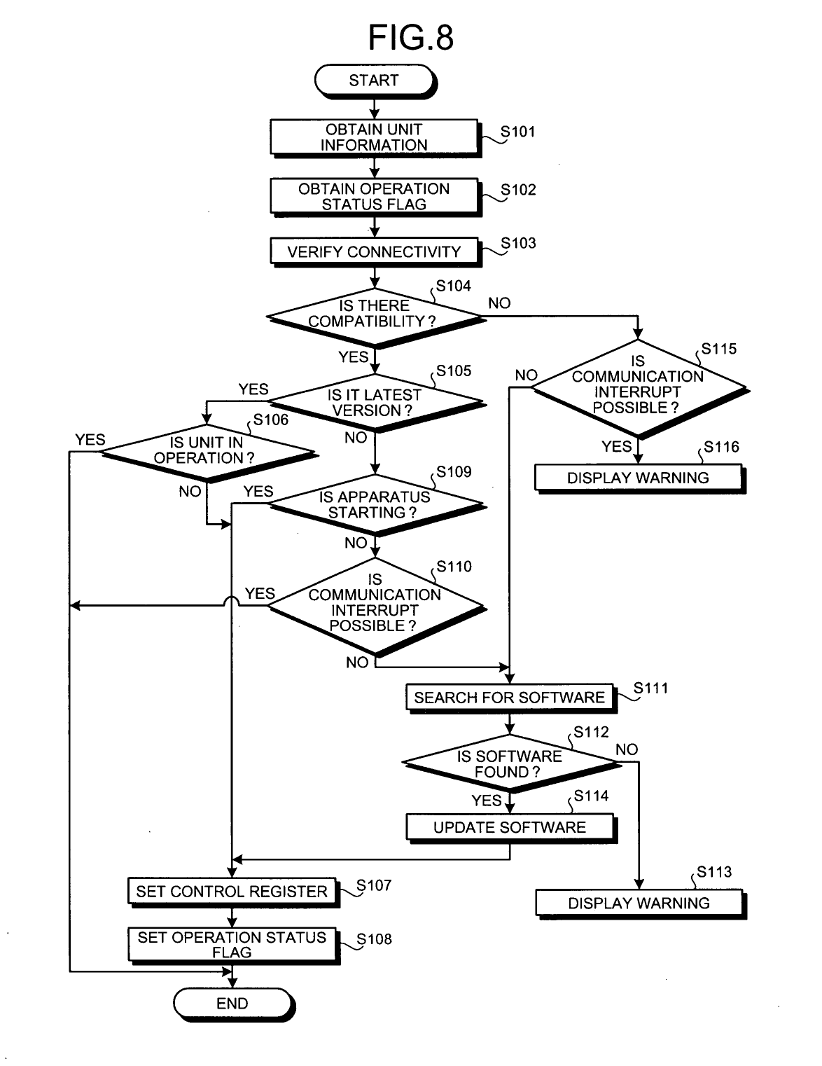

A process procedure of the transmission apparatus 10 according to the present embodiment will be explained next. FIG. 8 is a flowchart of a process procedure of the transmission apparatus 10 according to the present embodiment. In the process procedure shown in FIG. 8, when the unit detector 431 detects a communication control unit and the like, the automatic-update-necessity determining unit 434 determines the necessity of automatically updating software.

The process procedure in FIG. 8 determines the necessity of automatically updating software in regard to one target communication control unit. When making this determination for a plurality of target communication control units, this process procedure is repeatedly executed for each of them.

As shown in FIG. 8, according to a command from the automatic-update-necessity determining unit 434, the connectivity determining unit 432 obtains the unit information 121 of the target communication control unit (step S101), and the communication-interrupt determining unit 433 obtains the operation status flags 131 of the target communication control unit (step S102).

The connectivity determining unit 432 compares the unit information 121 with the connectivity management table 421, and verifies whether the software of the target communication control unit has connectivity (step S103).

When the connectivity determining unit 432 determines that the software in the target communication control unit is compatible with the software that achieves the function of the operation monitoring unit 410, and it is the latest version (step S104: Yes, and step S105: Yes), the automatic-update-necessity determining unit 434 determines that an automatic update of the software is unnecessary, and allows the unit controller 436 to execute normal processing.

If the target communication control unit is executing an operation (step S106: Yes), the unit controller 436 allows it to continue without change. If the target communication control unit is not executing an operation (step S106: No), the unit controller 436 switches it to operating status by setting predetermined parameters in the control register 140 of the communication control unit (step S107), and sets the operation status flags 131 of the communication control unit to flags indicating that it is operational, etc. (step S108).

At step S103, when the connectivity determining unit 432 determines that the software in the target communication control unit, while compatible with software that achieves the function of the operation monitoring unit 410, is not the latest version (step S104: Yes, and step S105: No), if the transmission apparatus is starting (step S109: Yes), the automatic-update-necessity determining unit 434 determines that an automatic update of the software is unnecessary, and allows the communication-interrupt determining unit 433 to execute normal processing.

In this case, since the target communication control unit is not operating, the unit controller 436 switches it to operating status by setting predetermined parameters in the control register 140 (step S107), and sets the operation status flags 131 to flags indicating that it is operational, etc. (step S108).

At step S103, when the connectivity determining unit 432 determines that the software in the target communication control unit, while compatible with software that achieves the function of the operation monitoring unit 410, is not the latest version (step S104: Yes, and step S105: No), if the transmission apparatus is not starting (step S109: No), the automatic-update-necessity determining unit 434 switches processing in accordance with the determination result of the communication-interrupt determining unit 433.

That is, when the communication-interrupt determining unit 433 determines that there is a possibility of communication being interrupted by software installation (step S110: Yes), the automatic-update-necessity determining unit 434 determines that an automatic update of the software is unnecessary. In this case, since the target communication control unit ought to be operating already, the communication-interrupt determining unit 433 ends the process without sending a command to other processors.

On the other hand, when the communication-interrupt determining unit 433 determines that there is no possibility of communication being interrupted by software installation (step S110: No), the automatic-update-necessity determining unit 434 determines that an automatic update of the software is necessary, and commands the software automatic-update unit 435 to execute an automatic update process of the software.

In this case, the software automatic-update unit 435 searches for a file name of software suitable for the target communication control unit in the software management table (step S111) and, if no such file name can be found (step S112: No), makes a predetermined warning unit display a warning of the fact before ending the process (step S113).

When the software automatic-update unit 435 finds a corresponding file name at step S111 (step S112: Yes), it extracts a file of that name from the software storage unit 423 and transfers the file name to the software storage unit 150 of the target communication control unit (step S114). The software automatic-update unit 435 then makes the unit controller 436 set the control register 140 (step S107) and set the operation status flags 131 (step S108), such that the installed software will function.

At step S103, when the connectivity determining unit 432 determines that the software of the target communication control unit is not compatible with the software that achieves the function of the operation monitoring unit 410 (step S104: No), the automatic-update-necessity determining unit 434 switches processing in accordance with the determination result of the communication-interrupt determining unit 433.

That is, when the communication-interrupt determining unit 433 determines that there is a possibility of communication being interrupted by software installation (step S115: Yes), the automatic-update-necessity determining unit 434 determines that an automatic update of the software is unnecessary. In this case, since the operation monitoring unit 410 cannot monitor the operation of the target communication control unit, the communication-interrupt determining unit 433 makes a predetermined warning unit display a warning indicating this fact (step S116).

On the other hand, when the communication-interrupt determining unit 433 determines that there is no possibility of communication being interrupted by software installation (step S115: No), the automatic-update-necessity determining unit 434 determines that an automatic update of the software is necessary, and commands the software automatic-update unit 435 to execute a process of automatically updating the software.

In this case, the software automatic-update unit 435 searches for a file name of software that is suitable for the target communication control unit in the software management table (step S111) and, if no such file name can be found (step S112: No), makes a predetermined warning unit display a warning of that fact before ending the process (step S113).

When the software automatic-update unit 435 finds a corresponding file name at step S111 (step S112: Yes), it extracts a file of that name from the software storage unit 423 and transfers the file name to the software storage unit 150 of the target communication control unit (step S114). The software automatic-update unit 435 then makes the unit controller 436 set the control register 140 (step S107) and set the operation status flags 131 (step S108), such that the installed software will function.

As described above, in the present embodiment, when new software is installed in a communication control unit, a determination regarding whether to automatically update the software in the communication control unit is made by taking as references not only consistency between the software versions, but also the matter of whether communication control being executed at that communication control unit will be interrupted. Therefore, software in the communication control unit can be automatically updated without interrupting the communication it is executing.

While the above embodiment relates to an example where the software automatic update method of the invention is applied in a transmission apparatus, the method can also be effectively applied in various apparatuses on which units are mounted. Note that the configurations described in the present embodiments can be variously modified without departing from the scope of the present invention.

As described above, according to one aspect of the present invention, when new software is installed in a unit, determination regarding whether to automatically update the software is made by taking as a reference not only consistency between the software versions, but also the matter of whether communication control being executed at the unit will be interrupted. Therefore, the software in the unit can be automatically updated without interrupting the communication it is executing.

Furthermore, according to another aspect of the present invention, even if the software versions are inconsistent, if communication control being executed by the unit will be interrupted when new software is installed in it, the software automatic update process is not executed. Therefore, communication being executed by the unit can be prevented from being interrupted by the software automatic update process.

Moreover, according to still another aspect of the present invention, even when the software in the unit is not the latest version, if communication control being executed by the unit will be interrupted when new software is installed in it, the software automatic update process is not executed. Therefore, communication being executed by the unit can be prevented from being interrupted by the software automatic update process.

Furthermore, according to still another aspect of the present invention, when the software in the unit, although compatible with software in the transmission apparatus, is not the latest version, if the transmission apparatus is starting, the software automatic update process is not executed. Therefore, when reactivating to repair damage, this configuration can prevent an increase in activation time caused by the software automatic update process, and an increase in the communication interruption time.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A transmission apparatus in which a plurality of detachable communication control units can be mounted, the transmission apparatus comprising:
a first determining unit that compares version information of a first software installed in a communication control unit with version information of a second software installed in the transmission apparatus, and determines whether information can be exchanged normally between the communication control unit and the transmission apparatus;
a second determining unit that determines whether a communication control being executed by the communication control unit is interrupted by an update of the first software;
a third determining unit that determines whether to execute a process of automatically updating the first software, based on results of determination by the first determining unit and the second determining unit; and
an updating unit that installs a software stored in a predetermined storage unit to the communication control unit, when the third determining unit determines that the process of automatically updating the first software is necessary.

2. The transmission apparatus according to claim 1, wherein
upon the first determining unit determining that the first software is not compatible with the second software, the third determining unit determines, when the second determining unit determines that the communication control is interrupted by the update of the first software, that the process of automatically updating the first software is unnecessary, and when the second determining unit determines that the communication control is not interrupted by the update of the first software, that the process of automatically updating the first software is necessary.

3. The transmission apparatus according to claim 1, wherein
upon the first determining unit determining that the first software is not a latest version although the first software is compatible with the second software, the third determining unit determines, when the second determining unit determines that the communication control is interrupted by the update of the first software, that the process of automatically updating the first software is unnecessary, and when the second determining unit determines that the communication control is not interrupted by the update of the first software, that the process of automatically updating the first software is necessary.

4. The transmission apparatus according to claim 3, wherein
upon the first determining unit determining that the first software is not a latest version although the first software is compatible with the second software, if the transmission apparatus is running, the third determining unit determines that the process of automatically updating the first software is unnecessary, regardless of the result of determination by the second determining unit.

5. The transmission apparatus according to claim 2, wherein
upon the first determining unit determining that the first software is not compatible with the second software, the third determining unit determines, when the second determining unit determines that the communication control is interrupted by the update of the first software, that the process of automatically updating the first software is unnecessary, and causes a predetermined warning display unit to display a warning indicating a loss of connectivity between the first software and the second software.

6. The transmission apparatus according to claim 1, wherein
the second determining unit is a volatile memory provided in the communication control unit, and
when information indicating that the communication control unit is running is not stored in a volatile memory for storing the information at a time starting an operation of the communication control unit, the second determining unit determines that the communication control being executed by the communication control unit is not interrupted by the update of the first software of the communication control unit.

7. The transmission apparatus according to claim 1, wherein
when information indicating that the communication control unit is allowed to uninterruptedly update the first software is stored in a predetermined storage unit, the second determining unit determines that the communication control being executed by the communication control unit is not interrupted by the update of the first software of the communication control unit.

8. The transmission apparatus according to claim 1, wherein
the first determining unit determines whether the first software is compatible with the second software, based on information, which is stored in the communication control unit, indicating ranges of a current version of the first software and a version with which the first software has a lower compatibility and information indicating which version of the first software is compatible with the second software.

9. A method of automatically updating a software installed in a communication control unit by a transmission apparatus in which a plurality of detachable communication control units can be mounted, the method comprising:
first determining including
comparing version information of a first software installed in a communication control unit with version information of a second software installed in the transmission apparatus; and
determining whether information can be exchanged normally between the communication control unit and the transmission apparatus;
second determining including determining whether a communication control being executed by the communication control unit is interrupted by an update of the first software;
third determining including determining whether to execute a process of automatically updating the first software, based on results of determination at the first determining and the second determining; and
installing a software stored in a predetermined storage unit to the communication control unit, when it is determined that the process of automatically updating the first software is necessary at the third determining.

10. The method according to claim 9, wherein
when it is determined that the first software is not compatible with the second software at the first determining, the third determining includes
determining, when it is determined that the communication control is interrupted by the update of the first software at the second determining, that the process of automatically updating the first software is unnecessary; and
determining, when it is determined that the communication control is not interrupted by the update of the first software at the second determining, that the process of automatically updating the first software is necessary.

11. The method according to claim 9, wherein
when it is determined that the first software is not a latest version although the first software is compatible with the second software at the first determining, the third determining includes
determining, when it is determined that the communication control is interrupted by the update of the first software at the second determining, that the process of automatically updating the first software is unnecessary; and
determining, when it is determined that the communication control is not interrupted by the update of the first software at the second determining, that the process of automatically updating the first software is necessary.

12. The method according to claim 11, wherein
when it is determined that the first software is not a latest version although the first software is compatible with the second software at the first determining, if the transmission apparatus is running, the third determining includes determining that the process of automatically updating the first software is unnecessary, regardless of the result of determination at the second determining.

13. The method according to claim 10, wherein
when it is determined that the first software is not compatible with the second software at the first determining, the third determining includes
determining, when it is determined that the communication control is interrupted by the update of the first software at the second determining, that the process of automatically updating the first software is unnecessary; and
causing a predetermined warning display unit to display a warning indicating a loss of connectivity between the first software and the second software.

14. The method according to claim 9, wherein
the second determining is performed in a volatile memory provided in the communication control unit, and
when information indicating that the communication control unit is running is not stored in a volatile memory for storing the information at a time starting an operation of the communication control unit, the second determining includes determining that the communication control being executed by the communication control unit is not interrupted by the update of the first software of the communication control unit.

15. The method according to claim 9, wherein
when information indicating that the communication control unit is allowed to uninterruptedly update the first software is stored in a predetermined storage unit, the second determining includes determining that the communication control being executed by the communication control unit is not interrupted by the update of the first software of the communication control unit.

16. The method according to claim 9, wherein
the first determining includes determining whether the first software is compatible with the second software, based on information, which is stored in the communication control unit, indicating ranges of a current version of the first software and a version with which the first software has a lower compatibility and information indicating which version of the first software is compatible with the second software.
